(19) United States
(12) Patent Application Publication
(10) Pub. No.: US 2006/0175570 A1
(43) Pub. Date: Aug. 10, 2006

(54) Valve assembly

(75) Inventors: Micha Alexander Held, Delft (NL); Arthur Frans Van der Knaap, Den Haag (NL); Marcus Johannes Voskuil, Oegstgeest (NL)

Correspondence Address: MARSHALL, GERSTEIN & BORUN LLP, 233 S. WACKER DRIVE, SUITE 6300, SEARS TOWER, CHICAGO, IL, 60606, US

(73) Assignee: FLUID MANAGEMENT OPERATIONS LLC, Wheeling, IL (US)

(21) Appl. No.: 11/051,709

(22) Filed: Feb. 4, 2005

(51) Int. Cl. F16K 5/06; B67D 5/60

(52) U.S. Cl. 251/315.03; 222/144

(57) ABSTRACT

A valve assembly comprising a housing and a valve member mounted within the housing rotatable about an axis and between at least a dispensing position and a further position, for instance a volume selection position during which a material can be withdrawn from a container, wherein at least one of said housing and said valve member is made of a synthetic material and the assembly further comprises a spring, which urges the valve member towards or onto an inner wall of the housing.

### TECHNICAL FIELD

A valve assembly, a pump for a viscous fluid, and an apparatus for dispensing fluids.

### BACKGROUND OF THE RELATED ART

Valve assemblies for viscous fluid dispensers are known e.g. from international patent application WO 03/083334. This document discloses a valve assembly for a fluid dispenser including a housing having at least a first opening (19) and a second opening (20), and a valve member fitted in the housing, the valve member (15) being rotatable about an axis and comprising a first channel (22), extending along said axis and communicating with the first opening in the housing, and at least two outlet channels (23, 24) radially extending from the first channel to the circumference of the valve member, wherein each of the radially extending outlet channels can be brought in register with the second opening by rotating the valve member.

U.S. Pat. No. 6,595,240 relates to a three-way plastic diaphragm valve provided with a rather complicated creep compensation system, which compensates for compression of internal valve components as well as extension of the valve body. In a manually operated three-way valve embodiment of U.S. Pat. No. 6,595,240, a trapped spring mechanism inserted between an actuator portion and an upper valve member provides the closure force for the upper valve member on the upper valve seat. An example of the spring mechanism is shown in FIG. 7.

### SUMMARY OF THE DISCLOSURE

An improved valve assembly is disclosed which comprises:

a housing and

a valve member mounted within the housing rotatable about an axis and between at least a dispensing position and a further position, for instance a volume selection position during which a material can be withdrawn from a container,
wherein at least one of said housing and said valve member is made of a synthetic material, and
wherein the assembly further comprises a spring, which urges the valve member towards or onto an inner wall of the housing.

It is preferred that the housing comprises an opening, preferably an outlet opening or an opening communicating with an outlet, surrounded by a first seat and the valve member comprises at least one radially extending (outlet) channel, which can be brought in register with the opening by rotating the valve member, wherein the said spring urges the valve member against this seat.

It is further preferred that the housing comprises at least a second opening, preferably communicating with an inlet connected or connectable to a pump or a container, surrounded by a second seat, and wherein the valve member is clamped between the first and second seats by the said spring.

The disclosed valve assembly can be manufactured in part or entirely from one or more synthetic materials and hence is relatively inexpensive when compared to similar valve assemblies made of metal. Creep resulting from the use of synthetic material(s) is compensated for in an effective manner, which preferably allows a relatively straightforward and robust design of the valve assembly.

The disclosed valve a pump for a viscous fluids comprising the valve assembly described above and a pump mechanism associated with the said assembly.

Finally, the disclosed valve can be used in an apparatus for dispensing fluids, the comprises:

a turntable rotatable around an axis of rotation;

a plurality of pumps attached to and distributed around the axis of the turntable;

at least one of the pumps comprising a valve assembly described above.

### BRIEF DESCRIPTION OF THE DRAWINGS

The disclosed valve assembly, pump and apparatus will be further explained with reference to the accompanying drawings in which a presently preferred embodiment is shown schematically.

FIG. 1 is a perspective view of part of a disclosed apparatus for dispensing viscous fluids;

FIG. 2 is a perspective view of a disclosed valve assembly suitable for use in the apparatus of FIG. 1;

FIG. 3 is a cross-sectional front view of the valve assembly of FIG. 2; and

FIG. 4 is a cross-sectional side view of the valve assembly of FIG. 2.

It is noted that the drawings are not necessarily to scale and that details, which are not necessary for an understanding of the disclosed valves, may have been omitted. As a matter of course, the disclosure is not limited to the particular embodiments illustrated herein.

### DETAILED DESCRIPTION OF THE PRESENTLY PREFERRED EMBODIMENTS

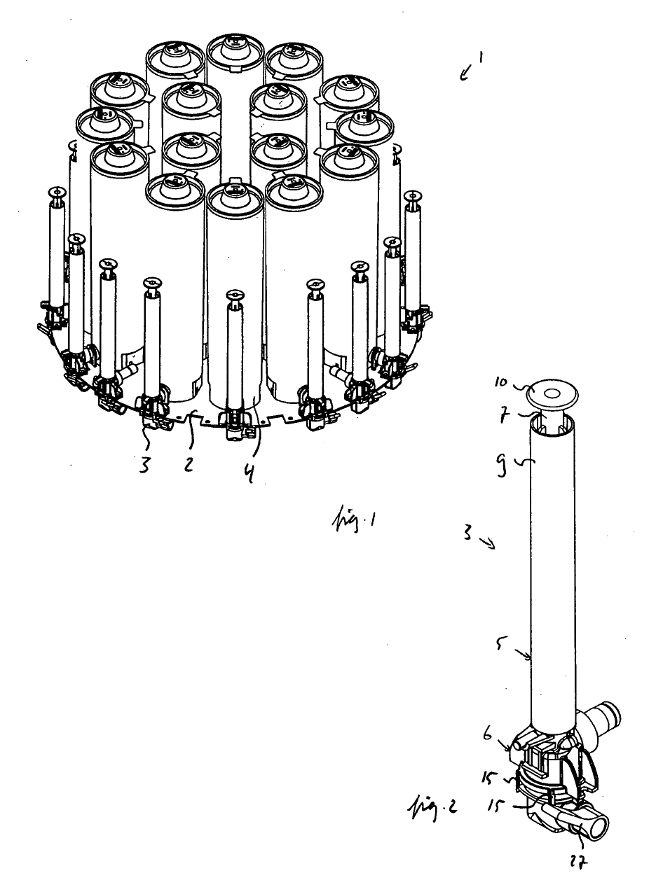

FIG. 1 illustrates the primary parts of a preferred embodiment of an apparatus 1 for dispensing viscous fluids, such as shampoos, conditioners, foundations, hair dyes, and/or components thereof. Other examples of viscous fluids that can be dispensed with the apparatus 1 are colorants, base paints, and paint components for decorative purposes, such as masonry paints, and/or industrial purposes.

This particular dispensing apparatus 1 includes a turntable 2, which is rotatable about a vertical axis by means of a drive (not shown) in order to rotate the turntable 2 between discrete positions. On the turntable 2, there are mounted a plurality of pumps 3, e.g., sixteen pumps. Each pump 3 is associated with a fluid container 4 comprising a replaceable flexible package (not shown) contained in a rigid, removable holder. When a flexible package is empty, the package and the holder containing it can be removed. Subsequently, the holder can be opened to take out the empty package and to insert a new, filled package, upon which the holder and the filled package can be placed back in the original position. Further details of the said apparatus are disclosed in U.S. Pat. No. 6,273,298, the contents of which are incorporated herein by reference.

FIGS. 2 to 4 show an embodiment of a pump 3 suitable for use in the apparatus of FIG. 1 and comprising a pump mechanism 5 and a valve assembly 6.

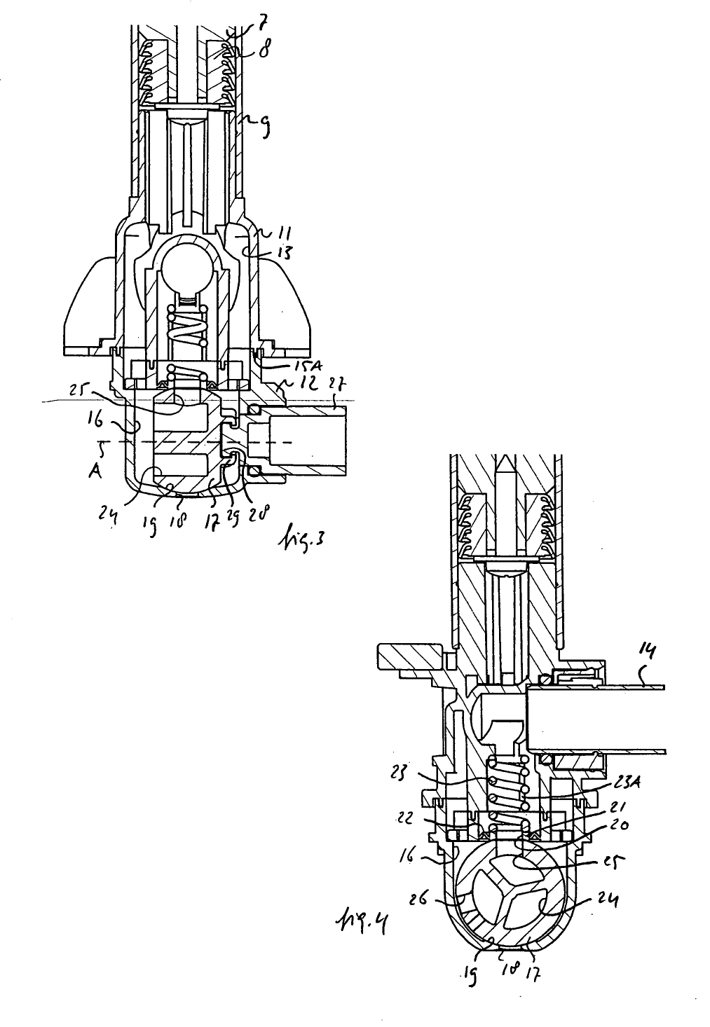

The pump mechanism 5 is of the piston-type and includes a piston rod 7 provided with a piston 8 (see FIGS. 2 and 3), disposed within a cylinder 9, and an upper flange 10. The flange 10 can be engaged by an actuator (not shown) adapted to move the piston rod 7 and the piston 8 upwards during an intake stroke and downwards during a discharge stroke. The actuator is stationary and the turntable 2 is adapted to position one pump 3 at a time in line with the actuator in order to enable it to actuate the pump mechanism 5.

The valve assembly comprises an upper housing 11, onto which the cylinder 9 is mounted, and a lower housing 12. The upper housing 11 defines a first cavity 13 that communicates with the cylinder 9 and an inlet channel 14 that is separated from the cavity 13 and adapted to be in fluid communication with a fluid container 4 as shown in FIG. 1.

The lower housing 12 is snap-fitted to the upper housing 11 by means of a plurality of resilient fingers 15 (FIG. 2). The connection between the lower and upper housings 11, 12 is further supported by a tongue and groove joint 15A (FIG. 3) and, upon assembly of the apparatus shown in FIG. 1, by a flange (not shown) on the turntable 2. The lower housing 12 defines a second cavity 16, which communicates, via the first cavity 13, with the pump mechanism 5. A valve member, preferably a ball-shaped valve 17, is fitted inside the second cavity 16 rotatable about an axis A. The lower housing 12 further includes a first or outlet opening 18 surrounded by a first seat 19 forming an integral part of the bottom wall of the lower housing 12 and a second or inlet opening 20, which communicates with the inlet channel 14 and which is surrounded by a second seat 21. The second seat 21 is mounted in the upper housing 11 by means of a resilient membrane 22, which seals off the second cavity 16 with respect to the inlet channel 14.

At least the valve member 17 and the housings 11, 12 are made from a synthetic material, such as poly(oxymethylene) (POM), polyamide (PA or Nylon®) or polyethylene (PE), e.g. by means of injection molding. However, it is preferred that all parts described above are made from a synthetic material.

Further, it is generally preferred that at least one of the seats, preferably both, are curved and that the radius of curvature of the seat(s) is larger than the radius of the valve member, thus obtaining a tighter seal between the seat(s) and the valve member.

A helical spring 23, preferably made from a metal such as stainless steel (304 or 316) is located on top of the second seat 21, such that the valve member 17 is clamped between the two seats 19, 21, thus compensating for compression of internal valve components, in this example the seats 19, 21 and the valve member 17, as well as extension of the lower housing 12. The helical spring 23 is preferably positioned between guide members 23A. In an alternative embodiment, the membrane serves both as a seal and as a spring, obviating the need for a separate spring.

The valve member 17 includes first channels 24, extending along, i.e. co-axial with or parallel to, the axis A and discharging into the second cavity 16. It further includes an inlet channel 25 and an outlet channel 26, both radially extending from one of the first channels 24 to the circumference of the valve member 17. The valve member 17 can be operated by means a lever 27 (FIGS. 1 and 3). To facilitate assembly, it is preferred that one end of the lever 27 is provided with a protrusion 28 or a slot, that the valve member 17 is provided with respectively a complementary slot 29 or protrusion, and that the protrusion 28 is slidingly received in the slot 29, preferably such that rotation of the lever 27 relative to the valve member 17 is substantially avoided.

FIGS. 3 and 4 show the intake position of the valve member 17, where the inlet channel 25 of the valve member 17 is in registry with the second opening 20 and thus with the inlet channel 14. In this position, the cavities 13, 16 and cylinder 9 can be filled with a desired amount of the fluid from a container connected to the inlet channel 14 by moving the piston 8 upwards over a desired or predetermined length.

As soon as an appropriate amount of fluid has been taken in, the valve member 17 is rotated to the dispensing position, i.e. until the outlet channel 26 is in registry with the outlet opening 18, which in this particular embodiment amounts to a rotation of respectively 50°, and the piston 8 is moved downwards to dispense the a desired amount of the fluid from the said opening 18.

The valve disclosed assembly is preferably made from one or more synthetic materials and hence relatively inexpensive when compared to valve similar valve assemblies made of metal. Creep resulting from the use of synthetic material is compensated for in an effective manner, allowing a relatively straightforward and robust design of the valve assembly.

The valve assembly is not restricted to the embodiment shown in the drawing and described herein before. For example, the valve member can be provided with two or more outlet channels having different diameters, so as to facilitate dispensing different (larger and smaller) volumes. Also, the valve assembly can be mounted directly onto or into (the bottom part of) a container, i.e., without the presence of a pump mechanism.

As a matter of course, this disclosure is not restricted to the above-disclosed embodiment and can be varied in numerous ways still falling within the scope of the appended claims. For instance, the spring can be located inside the valve member urging it to expand or could take the shape of a resilient bracket mounted about at least the valve member and the housing thus urging the same together.

What is claimed:

1. A valve assembly comprising:
a housing and
a valve member mounted within the housing rotatable about an axis and between at least a dispensing position and a further position,
wherein at least one of said housing and said valve member is made of a synthetic material and
the assembly further comprises a spring, which urges the valve member towards or onto an inner wall of the housing.

2. The valve assembly of claim 1,
wherein the housing comprises an opening, preferably an outlet opening or an opening communicating with an outlet, surrounded by a first seat and
wherein the valve member comprises at least one radially extending channel, which can be brought in register with the opening by rotating the valve member, and
wherein the said spring urges the valve member against this seat.

3. The valve assembly of claim 2 comprising a second seat, wherein the valve member is clamped between the first and second seats by the said spring.

4. The valve assembly of claim 3, wherein the housing comprises at least a second opening, preferably communicating with an inlet connected or connectable to a pump or a container, which opening is surrounded by the second seat.

5. The valve assembly of claim 4, wherein the second seat is mounted to the housing by means of a membrane, which membrane seals the space between the seat and the housing.

6. The valve assembly of claim 2, wherein the housing defines a cavity which communicates with a pump mechanism; and
the valve member comprises a channel which extends along the rotational axis of the valve member and communicates with the cavity.

7. The valve member of claim 6, wherein the valve member comprises a further radially extending channel, and
wherein the further channel can be brought in register with the second opening by rotating the valve member.

8. The valve assembly of claim 2, wherein the seat is an integral part of the housing.

9. The vale assembly of claim 2, wherein the seat is curved and wherein the radius of curvature of the seat is larger than the radius of the valve member.

10. The valve assembly of claim 1, which comprises a lever for rotating the valve member and
wherein one end of the lever is provided with a protrusion or a slot, and
the valve member is provided with respectively a complementary slot or protrusion, and
wherein the protrusion is slidingly received in the slot.

11. The valve assembly of claim 1, wherein the valve member is substantially ball-shaped.

12. The valve assembly of claim 1, wherein the spring is a helical spring.

13. The valve assembly of claim 12, wherein the housing comprises guide members, which define a space for retaining the helical spring.

14. A pump for a viscous fluid comprising the valve assembly of claim 1 and a pump mechanism associated with the said assembly.

15. An apparatus for dispensing fluids, comprising:
a turntable rotatable around an axis of rotation;
a plurality of pumps attached to and distributed around the axis of the turntable;
at least one of the pumps comprising a valve assembly according to claim 1.
